(19) United States
(12) Patent Application Publication
(10) Pub. No.: US 2025/0102222 A1
(43) Pub. Date: Mar. 27, 2025

(54) METAL POWDER DRYING APPARATUS USING A PLURALITY OF PLATES INCLUDING A HEATER

(71) Applicant: HIM TECHNOLOGIES CO., LTD, Bucheon-si (KR)

(72) Inventors: Young Geun SON, Bucheon-si (KR); Seo Wong SON, Bucheon-si (KR); Seo Jun SON, Bucheon-si (KR)

(21) Appl. No.: 18/622,092

(22) Filed: Mar. 29, 2024

(30) Foreign Application Priority Data
Sep. 27, 2023 (KR) 10-2023-0130395

(51) Int. Cl. F26B 3/20; F26B 11/14

(52) U.S. Cl. CPC F26B 3/20; F26B 11/14; F26B 2200/08

(57) ABSTRACT

A metal powder drying apparatus using a plurality of plates including a heater includes: a drying furnace having raw metal powder used in the manufacturing of the secondary battery input into one side thereof and having an upper portion in a hemispherical dome structure; a heating unit including the plurality of plates and provided on one side of the drying furnace to heat the drying furnace; a raw material input unit connected to the upper portion of the drying furnace and inputting the raw metal powder into the drying furnace; a stirring unit installed in the drying furnace and stirring the raw metal powder input into the drying furnace; a driving unit installed on an upper portion of the metal powder drying apparatus and providing a speed to the stirring unit; and a control unit controlling the heating unit, the stirring unit, and the driving unit.

### CROSS-REFERENCE TO RELATED APPLICATIONS

This application claims the priority of Korean Patent Application No.10-2023-0130395 filed on Sep. 27, 2023, in the Korean Intellectual Property Office, the disclosure of which is incorporated herein by reference.

### BACKGROUND

### Field

The present disclosure relates to a metal powder drying apparatus using a plurality of plates including a heater, and more particularly, to a metal powder drying apparatus using a plurality of plates including a heater capable of heating a drying furnace using the plurality of plates that is provided on one side of the drying furnace and includes the heater and a temperature sensor.

### Description of the Related Art

To produce a secondary battery, metal powders such as lithium, nickel, cobalt, and aluminum are required. In this case, the more moisture or impurities contained in the metal powders, the lower the quality of the secondary battery.

Accordingly, technologies to prevent moisture and impurities from being mixed into metal powders have been published in production facilities of the secondary battery.

In the applicant's registered patent, Korea Patent No. 10-2069461 (registration date: Jan. 16, 2020) entitled “Metal Powder Drying Apparatus and Drying Method for Manufacturing Secondary Battery,” a heating unit is provided on one side of a drying furnace and raises a temperature of the drying furnace with steam, and a vacuum pressure is formed in the drying furnace, thereby removing moisture in metal powders with low temperature steam and a hot boiler.

However, the conventional metal powder drying apparatus has the problem in that it takes a long time to maintain a constant temperature by heating a steam pipe or a hot oil pipe provided around a drying furnace to raise temperature, has the problem in that it is difficult to control the temperature since it is difficult to maintain the constant temperature, the problem in that it is difficult to raise the temperature to 200° C. or higher and there is a risk of fire, and the problem in that it is difficult to maintain and repair since a boiler and piping equipment takes up a lot of space. In addition, the conventional metal powder drying apparatus has the problem in that a

driving unit operates with two motors of low-speed rotation (0.5 to 1 RPM) and high-speed rotation (5 to 10 RPM) to make the operation inconvenient, the problem in that it uses an air clutch on a shaft connecting two motors to cut off or connect power but causes frequent breakdowns due to imbalance in air supply, and the problem in that the shaft is broken when connecting and disconnecting the shaft. In addition, when drying single crystals and small particles, a rotation speed of about 2 to 5 RPM is required when operating at low speed, but a current rotation speed has the disadvantage of taking a long drying time.

### RELATED ART DOCUMENT

### Patent Document

(Patent Document 0001) KR 10-2069461 B1 2020 Jan. 16
(Patent Document 0002) KR 10-2069462 B1 2020 Jan. 16

### SUMMARY

An object to be achieved by the present disclosure is to provide a metal powder drying apparatus using a plurality of plates including a heater capable of heating a drying furnace using the plurality of plates that is provided on one side of the drying furnace and includes the heater and a temperature sensor and improving operation convenience and shorten drying time using a single motor.

However, objects of the present disclosure are not limited to the above-described objects. That is, other objects that are not described may be obviously understood by those skilled in the art to which the present disclosure pertains from the following description.

According to an aspect of the present disclosure, there is provided a metal powder drying apparatus using a plurality of plates including a heater, including: a drying furnace having raw metal powder used in the manufacturing of the secondary battery input into one side thereof and having an upper portion in a hemispherical dome structure; a heating unit including the plurality of plates and provided on one side of the drying furnace to heat the drying furnace; a raw material input unit connected to the upper portion of the drying furnace and inputting the raw metal powder into the drying furnace; a stirring unit installed in the drying furnace and stirring the raw metal powder input into the drying furnace; a driving unit installed on an upper portion of the metal powder drying apparatus and providing a speed to the stirring unit; and a control unit controlling the heating unit, the stirring unit, and the driving unit, in which the plate includes: a heater provided inside the plate to receive power and generating heat; and a temperature sensor provided inside the plate to measure a temperature of the plate and transmitting a measured value to the control unit, the heating unit includes: a first heating unit including the plurality of plates at a center of a bottom surface of the drying furnace; a second heating unit including the plurality of plates along an outer side of the first heating unit at the bottom surface of the drying furnace; and a third heating unit including the plurality of plates on an outer side surface of the drying furnace in a circumferential direction, and the control unit controls a heat generation amount of each of the plurality of plates based on each of the measured values of temperature sensor.

In addition, heater heating wires are installed inside a shaft and wings of the stirring unit to prevent metal powder from adhering to the shaft and wings and to reduce a drying time.

Preferably, the plate may be made of any one of aluminum, iron, copper, an alloy thereof, and ceramics.

Preferably, when the plate is cast, the heater and the temperature sensor may be integrally cast.

Preferably, an inside of the drying furnace may be heated to 200 to 350° C. by operating the heater.

Preferably, the temperatures of the first heating unit and the second heating unit may be controlled to be higher than that of the third heating unit.

In addition, preferably, the driving unit has one deceleration motor installed in the stirring unit and operates at a rotation speed of 2 to 5 RPM when drying and 6 to 11 RPM when discharging.

Preferably, the plate of the first heating unit may be 3 to 6 plates equally divided radially from the center of the bottom surface of the drying furnace.

Preferably, the plate of the second heating unit may be 4 to 12 plates equally divided radially from the center of the bottom surface of the drying furnace.

Preferably, the plate of the third heating unit may have a curved rectangular shape and may be equally divided along a circumferential direction of the drying furnace.

The heater heating wires are built into the shaft and wings of the stirring unit to maintain a temperature of 150° C.

In addition, the third heating unit may include: a first side heating unit 214 arranged in a circle around the second heating unit and perpendicular to the second heating unit; and a second side heating unit 216 having the same configuration as the first side heating unit 214 and stacked on the first side heating unit 214.

Preferably, the plate may be further provided with a bolt hole for fixing the plate to the drying furnace.

Preferably, an insulating material may be further provided on an outer side of the plate.

Preferably, the metal powder drying apparatus may be a kettle dryer.

Preferably, the heating unit further includes at least one of: a shaft heater installed on a stirring shaft of the stirring unit; and a stirring blade heater provided on a stirring blade of the stirring unit.

According to an exemplary embodiment of the present disclosure, it is possible to shorten the time it takes to raise the temperature of the drying furnace by heating the drying furnace using the plurality of plates that include the heater and the temperature sensor.

In addition, it is possible to control the temperature inside the drying furnace to be constant by controlling the temperature of each of the plurality of heating units to a different temperature.

In addition, it is possible to shorten the drying time by heating the inside of the drying furnace to 200 to 350° C.

In addition, it is possible to eliminate the risk of fire compared to the conventional hot oil pipe heating method.

In addition, since there is no boiler or piping equipment, it is possible to take up less space.

In addition, it is possible to facilitate manufacturing, maintenance, and repair by simplifying the structure.

In addition, it is possible to heat the temperature of the drying furnace more quickly and uniformly by heating the stirring shaft and stirring blade of the drying furnace with the heater.

However, effects which can be achieved by the present disclosure are not limited to the above-described effects. That is, other effects that are not described may be obviously understood by those skilled in the art to which the present disclosure pertains from the following description.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a perspective view illustrating a metal powder drying apparatus using a plurality of plates including a heater according to the present disclosure;

FIG. 2 is a block diagram illustrating the metal powder drying apparatus using a plurality of plates including a heater according to the present disclosure;

FIG. 3A is a perspective view illustrating a heating unit of a metal powder drying apparatus using a plurality of plates including a heater according to a first exemplary embodiment of the present disclosure;

FIG. 3B is a perspective view illustrating a heating unit of a metal powder drying apparatus using a plurality of plates including a heater according to a second exemplary embodiment of the present disclosure;

FIG. 4 is a perspective view illustrating a plate of a first heating unit according to the present disclosure;

FIG. 5 is a perspective view illustrating a plate of a second heating unit according to the present disclosure;

FIG. 6 is a perspective view illustrating a plate of a third heating unit according to the present disclosure;

FIG. 7A is a cross-sectional view illustrating the metal powder drying apparatus using a plurality of plates including a heater according to the present disclosure;

FIG. 7B is a perspective view of an upper cover 220 in FIG. 7A;

FIG. 7C is a perspective view of a side cover 230 in FIG. 7A;

FIG. 7D is a bottom view of a lower cover 240 in FIG. 7A;

FIG. 8 is a plan view illustrating the metal powder drying apparatus using a plurality of plates including a heater according to the present disclosure;

FIG. 9 is a cross-sectional view illustrating a driving unit and a stirring unit of the metal powder drying apparatus using a plurality of plates including a heater according to the present disclosure; and

FIG. 10 is an internal cross-sectional view of a shaft connection part 320 illustrated in FIG. 7A.

### DETAILED DESCRIPTION OF THE PREFERRED EMBODIMENT

Hereinafter, exemplary embodiments of the present disclosure will be described in detail with reference to the accompanying drawings so that those skilled in the art to which the present disclosure pertains may easily practice the present disclosure. However, description of the present disclosure is only an exemplary embodiment for structural or functional description, and therefore the scope of the present disclosure should not be construed as limited to exemplary embodiments described in the text. That is, since the exemplary embodiments may be variously modified and may have various forms, the scope of the present disclosure should be construed as including equivalents capable of realizing the technical idea. In addition, a specific exemplary embodiment is not construed as including all the objects or effects presented in the present disclosure or only the effects, and therefore the scope of the present disclosure should not be understood as being limited thereto.

The meaning of the terms described in the present disclosure should be understood as follows.

Terms such as “first” and “second” are intended to distinguish one component from another component, and the scope of the present disclosure should not be limited by these terms. For example, a first component may be named a second component, and the second component may also be similarly named the first component. It is to be understood that when one element is referred to as being “connected to” another element, it may be connected directly to or coupled directly to another element or be connected to another element, having the other element intervening therebetween. On the other hand, it is to be understood that when one element is referred to as being “connected directly to” another element, it may be connected to or coupled to another element without the other element intervening therebetween. Meanwhile, other expressions describing a relationship between components, that is, “between,” “directly between,” “neighboring to,” “directly neighboring to,” and the like, should be similarly interpreted.

It should be understood that the singular expression includes the plural expression unless the context clearly indicates otherwise, and it will be further understood that the terms “comprise” or “have” used in this specification, specify the presence of stated features, numerals, steps, operations, components, parts, or a combination thereof, but do not preclude the presence or addition of one or more other features, numerals, steps, operations, components, parts, or a combination thereof.

Unless defined otherwise, all the terms used herein have the same meaning as meanings generally understood by those skilled in the art to which the present disclosure pertains. Terms defined in commonly used dictionaries should be interpreted as consistent with the meaning in the context of the related technology and cannot be interpreted as having an ideal or excessively formal meaning unless clearly defined in the present disclosure.

### Configuration of Disclosure

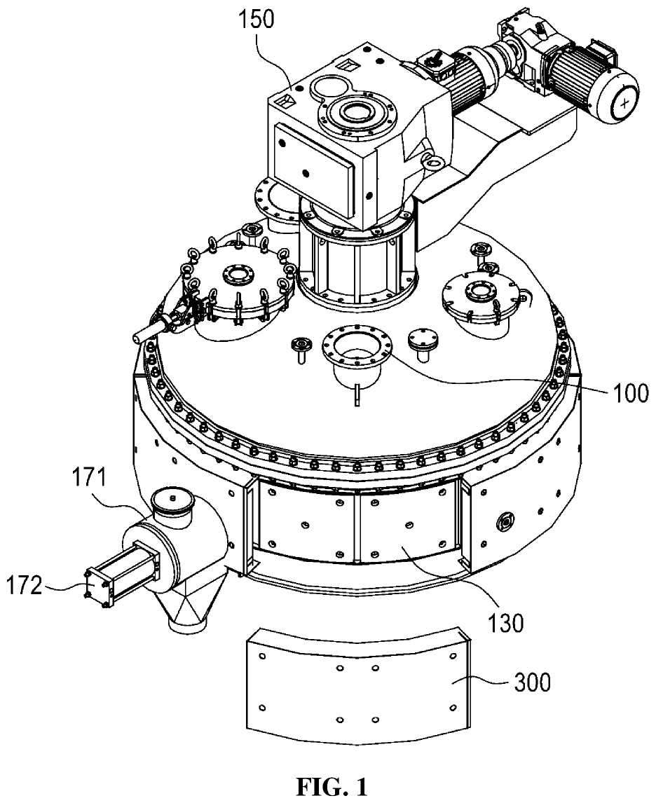

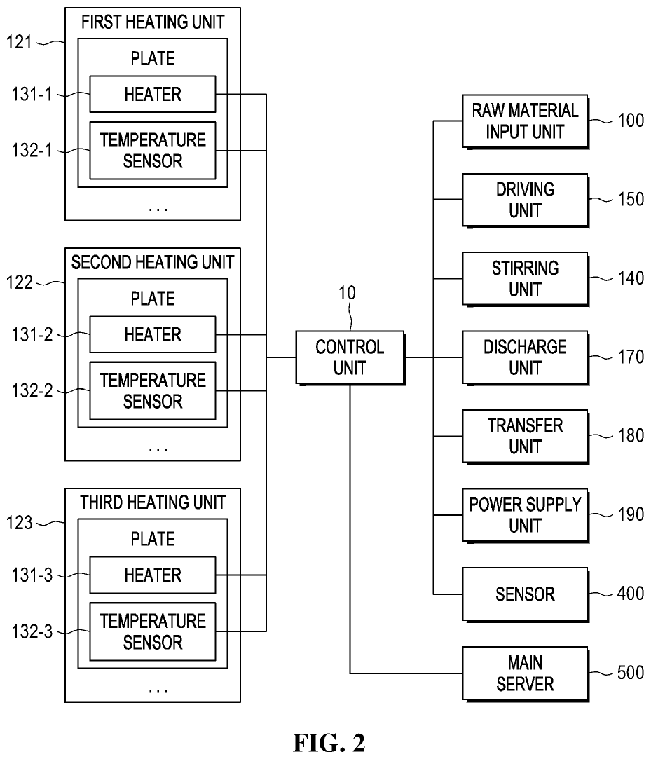

FIG. 1 is a perspective view illustrating a metal powder drying apparatus using a plurality of plates including a heater according to the present disclosure, and FIG. 2 is a block diagram illustrating the metal powder drying apparatus using a plurality of plates including a heater according to the present disclosure.

Referring to FIGS. 1 and 2, a metal powder drying apparatus using a plurality of plates including a heater (hereinafter referred to as “metal powder drying apparatus”) according to the present disclosure may include a raw material input unit 100, a heating unit 120, a stirring unit 140, a driving unit 150, a discharge unit 170, a transfer unit 180, a power supply unit 190, and a control unit 10, based on a drying furnace 110. The drying apparatus according to an exemplary embodiment of the present disclosure may be provided with additional necessary components.

The raw material input unit 100 may be installed on one side of the drying furnace 110 and input a certain amount of raw metal powder 105 for manufacturing secondary batteries into the drying furnace 110 according to control commands from the control unit 10. In this case, the raw material input unit 100 may be implemented as a screw feeder, a rotary feeder, a vibrator feeder, etc. In this case, the raw metal powder 105 introduced may be a metal powder containing at least one of lithium, nickel, cobalt, and aluminum.

In the drying furnace 110, the raw metal powder 105 is input into a lower portion 113 of the drying furnace from the raw material input unit 100, and the raw material input unit 100 and the driving unit 150 may be installed on the upper portion 111 of the drying furnace. In this case, the upper portion 111 of the drying furnace and the lower portion 113 of the drying furnace are coupled through a coupling part 115, and the drying furnace 110 may have a sealed structure through the coupling.

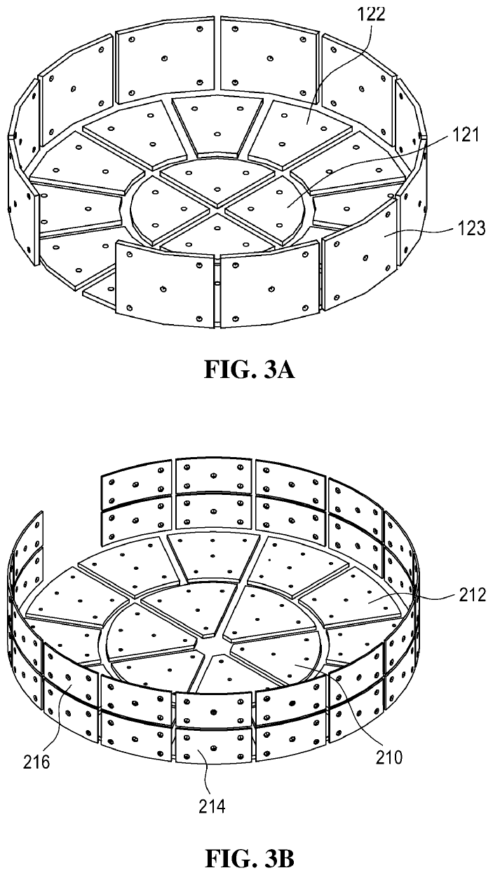

FIG. 3A is a perspective view illustrating a heating unit of a metal powder drying apparatus using a plurality of plates including a heater according to a first exemplary embodiment of the present disclosure.

Referring to FIGS. 1 and 3A, the heating unit 120 may include a first heating unit 121, a second heating unit 122, a third heating unit 123, a shaft heater 370, and a stirring blade heater 380. In this case, the first heating unit 121 is provided in a center of a bottom surface of the drying furnace 110 and is divided into four equal parts. The second heating unit 122 is provided along an outer side of the first heating unit 121 at a bottom surface of the drying furnace 110, has an annular shape, and is equally divided into 12 equal parts. The third heating unit 123 may be provided vertically on an outer side surface of the drying furnace 110 in the circumferential direction.

FIG. 3B is a perspective view illustrating a heating unit of a metal powder drying apparatus using a plurality of plates including a heater according to a second exemplary embodiment of the present disclosure. As illustrated in FIG. 3B, the heating unit 120 may include a first floor heating unit 210, a second floor heating unit 212, a first side heating unit 214, and a second side heating unit 216. In this case, the first floor heating unit 210 is provided in the center of the bottom surface of the drying furnace 110 and has a triangular shape divided into six equal parts. The second floor heating unit 212 is provided along an outer side of the first floor heating unit 210 at the bottom surface of the drying furnace 110, and has an arc shape divided into 12 equal parts. The first side heating unit 214 perpendicularly contacts a circumference of the second floor heating unit 212. The second side heating unit 216 is configured to be stacked on the first side heating unit 214.

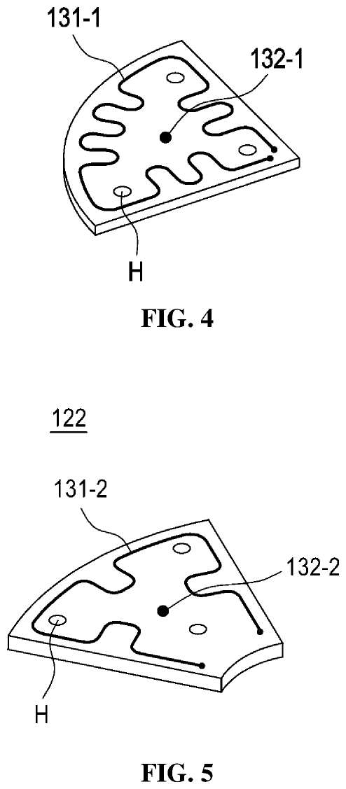

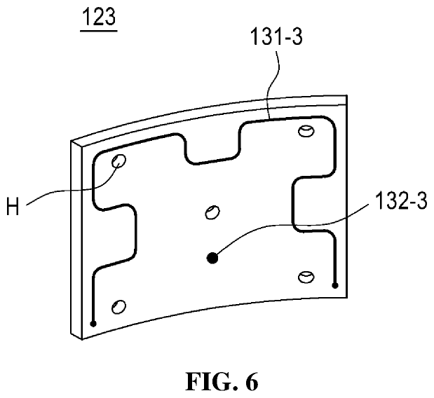

FIG. 4 is a perspective view illustrating a plate of a first heating unit according to the present disclosure, FIG. 5 is a perspective view illustrating a plate of a second heating unit according to the present disclosure, and FIG. 6 is a perspective view illustrating a plate of a third heating unit according to the present disclosure.

Referring to FIGS. 4 to 6, the first heating unit 121, the second heating unit 122, and the third heating unit 123 may each include a plurality of plates 130. In this case, the plate 130 may include a heater 131 and a temperature sensor 132 therein. In addition, the heater 131 is a sheathe heater that receives power from the power supply unit 190 under the control of the control unit 10 and generates heat. The heaters 131 may be arranged in a meandering and alternating form inside the plate 130 to uniformly heat the plate 130.

Additionally, the temperature sensor 132 may measure the temperature of the plate 130 and transmit the measured value to the control unit 10. In this case, the plate 130 may be manufactured by being cast into any one of aluminum, iron, copper, or alloys thereof, or may be made of ceramics. In addition, during the casting of the plate 130, the heater 131 and the temperature sensor 132 may be cast integrally. In addition, a plate 130_1 of the first heating unit 121 may be 3 to 6 plates 130_1 in a shape equally divided radially from the center of the bottom surface of the drying furnace 110. In addition, a plate 130_2 of the second heating unit 122 may be 4 to 12 plates 130_2 in a shape equally divided radially from the center of the bottom surface of the drying furnace 110. A plate 130_3 of the third heating unit 123 may be a curved rectangular plate 130_3 equally divided in the circumferential direction of the drying furnace 110. The first and second heating units 121 and 122 completely cover the bottom surface of the drying furnace 110, and the third heating unit 123 completely covers the side surface of the drying furnace 110.

Optionally, a fourth heating unit (not illustrated) of the same type may be installed on an upper surface of the drying furnace 110 to completely cover the upper surface.

In addition, one side of the plate 130 is provided with a bolt hole H for fixing the plate 130 to the drying furnace 110, so that the plate 130 may be coupled to the drying furnace 110 by a bolt.

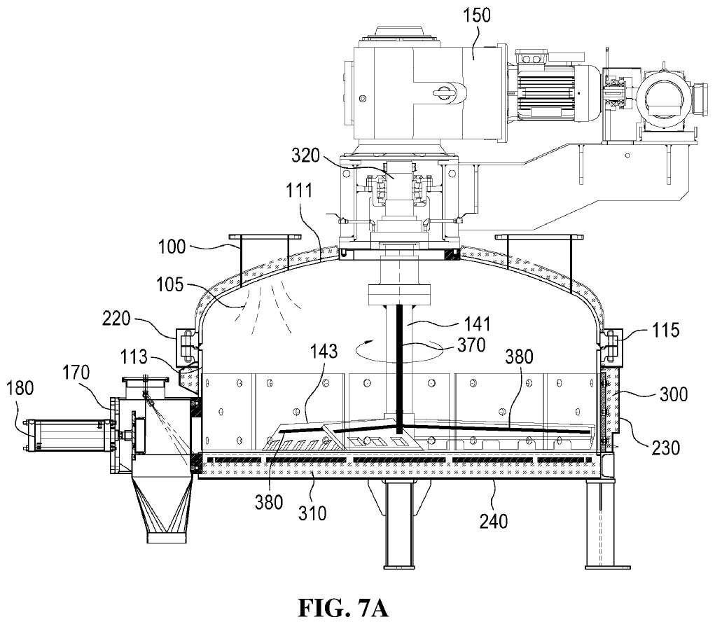

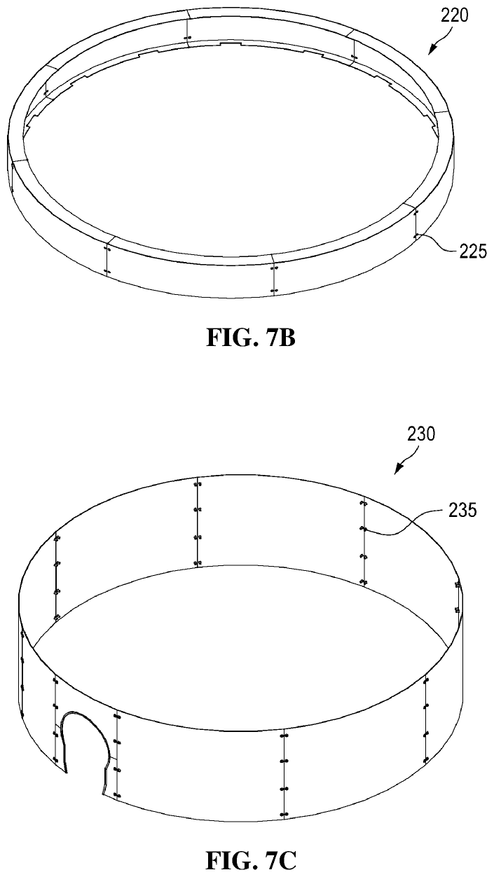

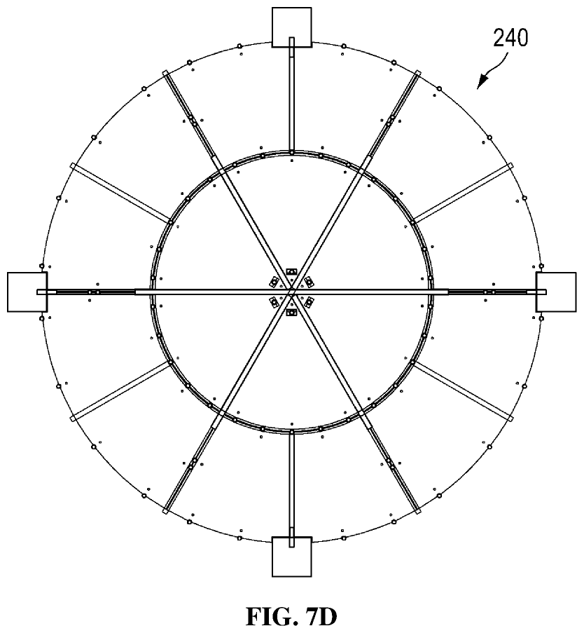

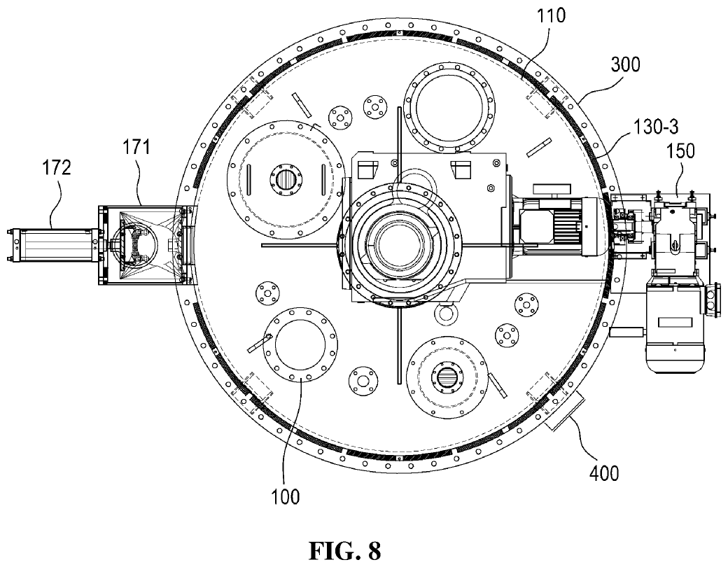

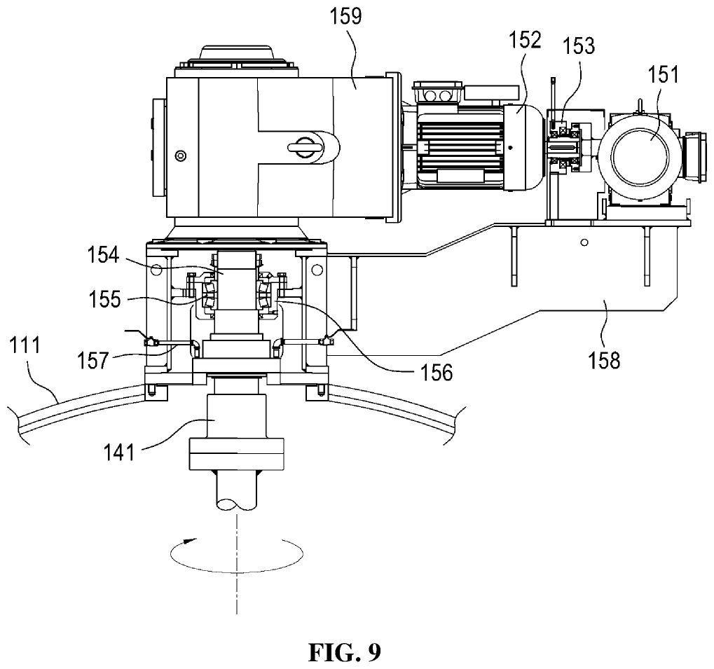

FIG. 7A is a cross-sectional view illustrating the metal powder drying apparatus using a plurality of plates including a heater according to the present disclosure, FIG. 8 is a plan view illustrating the metal powder drying apparatus using a plurality of plates including a heater according to the present disclosure, and FIG. 9 is a cross-sectional view illustrating a driving unit and a stirring unit of the metal powder drying apparatus using a plurality of plates including a heater according to the present disclosure.

Referring to FIGS. 7A to 9, the stirring unit 140 may be installed in the center of the upper portion of the drying furnace 110, and shaft-coupled to the driving unit 150 to stir the raw metal powder 105 while rotating by the driving unit 150. For this purpose, the stirring unit 140 may be configured to include a stirring shaft 141 and a stirring blade 143. In addition, the stirring shaft 141 may be vertically installed in the center of the drying furnace 110 and may have a lower end provided with the stirring blade 143, and an upper end coupled to the driving shaft 154 of the driving unit 150 to rotate based on a speed received from the driving unit 150.

The stirring blade 143 may be installed at a lower end of the stirring shaft 141 but installed to be spaced apart from an inner floor of the lower portion 113 of the drying furnace at a predetermined height. In this case, the stirring blade 143 may uniformly mix the raw metal powder 105 input into the drying furnace 110 through the rotation of the stirring shaft 141. In addition, the stirring blade 143 may have an inclination angle that pushes the raw metal powder 105 to an outer periphery while rotating. Therefore, it is possible to facilitate the discharge of the mixed metal powder that has been stirred.

The driving unit 150 may be provided with a deceleration motor and a driving shaft 154 that provide a speed to the stirring unit 140 for drying and discharging the raw metal powder 105. Here, the deceleration motor may generate a first speed which is the speed at which the raw metal powder 105 is dried. In this case, the first speed is 2 to 5 rpm and may be used to dry moisture contained in the raw metal powder 105 while stirring the raw metal powder 105. In addition, a second speed, which is the speed at which the raw metal powder 105 is discharged, may be generated. In this case, the second speed is 6 to 11 rpm which is a speed greater than the first speed and may be used when the raw metal powder 105 is pushed to the outer periphery of the lower portion 113 of the drying furnace and discharged to the outside.

A clutch 153 is shaft-coupled with the first motor 151, the second motor 152, and the driving shaft 154, and may be a device that allows the first and second speeds to be transmitted to the driving shaft 154 or blocks the first and second speeds from being transmitted. Here, the clutch 153 is an air clutch and may be pneumatically or hydraulically operated.

The driving unit 150 may further include a bearing 155, an oil seal 156, a cooling device air purge pipe 157, a support member 158, and a reducer 159. Here, the bearing 155 may be installed to surround the outer side of the driving shaft 154 and may support the driving shaft 154 rotating at the first or second speed from impact. In addition, the oil seal 156 may be installed in a housing adjacent to the driving shaft 154 to prevent leakage of oil input for smooth rotation of the driving shaft 154. In addition, a separate cooling device is provided on the upper portion of the driving shaft to preserve the seal of the shaft, and the air purge pipe 157 may be installed in the housing to remove air and moisture remaining in the housing through which the driving shaft 154 penetrates. In addition, the support member 158 may be installed at the lower portion to support a load of the deceleration motor. In addition, in the case of the reducer 159, it is desirable that the deceleration is understood to have the same meaning as shifting.

One or more sensors 400 may be installed in the drying furnace 110 to measure the moisture in the drying furnace 110 and the temperature and weight of the drying furnace 110. This sensor 400 may be provided as a single sensor to measure all the moisture, temperature, and weight, or may be provided separately as a moisture sensor, a temperature sensor, and a weight sensor. In addition, the moisture signal, temperature signal, and weight signal measured by the sensor 400 may be transmitted to the control unit 10. The control unit 10 may control the metal powder drying apparatus based on the measured moisture amount, temperature, and weight. The control unit 10 may determine whether to continue or complete the drying process according to the moisture amount measured by the sensor 400, control the heat generation amount of the heating unit 120 according to the temperature measured through the sensor 400, and detect the change in weight of the drying furnace 110 according to the weight measured by the sensor 400 to control the input of the raw metal powder 105 from the raw material input unit 100.

In addition, the metal powder drying apparatus may further include an insulating material 300. Here, the insulating material 300 may be provided on the outer side of the plate 130 of the heating unit 120 to prevent heat from escaping to the outside of the metal powder drying apparatus when the heater 131 of the plate 130 generates heat and transmit the generated heat to the drying furnace 110. The insulating material 300 is configured to cover the side and upper surfaces of the drying furnace 110 and is divided into a plurality of pieces to facilitate installation. Examples of the insulating material 300 may be glass fiber, carbon aramid silica glass, inorganic insulating material, ceramic wool, etc.

A floor insulating material 310 covers the bottom surface of the metal powder drying apparatus and blocks heat from the first and second floor heating units 210 and 212 from leaking to the outside. The floor insulating material 310 may be the same material as the insulating material 300.

The shaft heater 370 is installed on the stirring shaft 141 to heat the stirring shaft 141. The shaft heater 370 may be installed in a longitudinal direction along an axis direction of the stirring shaft 141 and installed inside the hollow stirring shaft 141.

The stirring blade heater 380 is installed on each of the three radial stirring blades 143 to heat the stirring blades 143. The stirring blade heater 380 is installed inside along the longitudinal direction of each stirring blade 143.

FIG. 7B is a perspective view of an upper cover 220 in FIG. 7A. As illustrated in FIG. 7B, the upper cover 220 covers the circumference of the coupling part 115 in an annular shape. The upper cover 220 protects the coupling part 115 and prevents external foreign substances from accumulating or corroding. The upper cover 220 is manufactured by connecting eight metal pieces with bolts, rivets, welding, etc. For this purpose, a plurality of connectors 225 are formed on each metal piece of the upper cover 220.

FIG. 7C is a perspective view of a side cover 230 in FIG. 7A. As illustrated in FIG. 7C, the side cover 230 covers an outermost circumference of the insulating material 300. The side cover 230 fixes the position of the insulating material 300 and protects the insulating material 300. The side cover 230 is manufactured by connecting 9 metal pieces with bolts, rivets, welding, etc. For this purpose, the plurality of connectors 235 are formed on each metal piece of the side cover 230. In particular, one of the side covers 230 has a cut part that is shaped to fit an outer diameter of a discharger 171 so as not to interfere with the discharger 171.

FIG. 7D is a bottom view of a lower cover 240 in FIG. 7A. As illustrated in FIG. 7D, the lower cover 240 supports and covers a bottom surface of the lower insulating material 310. The lower cover 240 is manufactured by connecting 6 metal pieces at the center and 12 metal pieces at the circumference with bolts, rivets, welding, etc.

Referring back to FIG. 2, the control unit 10 may control the heating unit 120, the stirring unit 140, and the driving unit 140, and control the heat generation amount of the heater 131 by an SCR unit based on the value measured by the temperature sensor 132 of the plate 130. Here, the internal temperature of the drying furnace 110 may be heated to 200 to 350° C. by operating the heater 131. In this case, the control unit 10 may control the temperatures of the first heating unit 121 and the second heating unit 122 to be higher than the third heating unit 123 in order to control the internal temperature of the drying furnace 110.

In addition, the metal powder drying apparatus may further include a main server 500. In this case, the main server 500 is connected to the control unit 10 to receive the information such as the measured value generated by the temperature sensor 132 of the plate 130 transmitted to the control unit, the stirring speed of the stirring unit 140, and the moisture signal, temperature signal, and weight signal measured by the sensor 400. In addition, a worker may monitor the information transmitted to the main server through a terminal (not illustrated) connected to the main server 500.

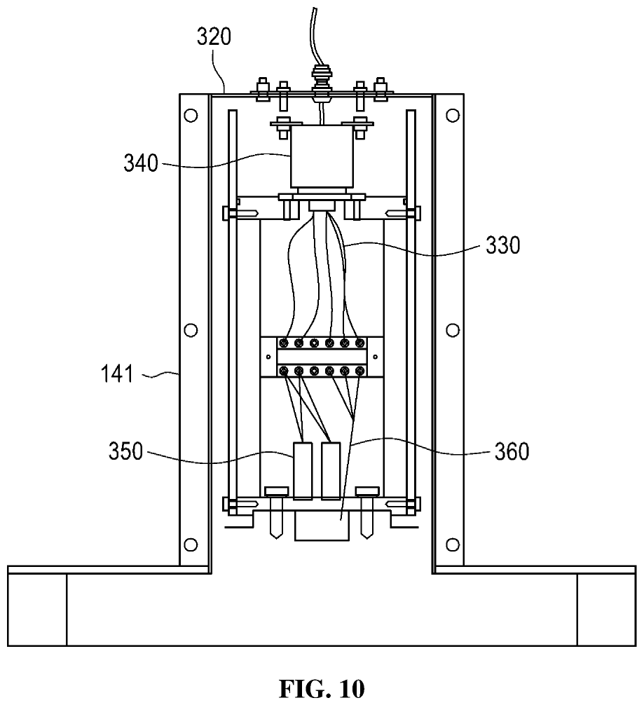

FIG. 10 is an internal cross-sectional view of the shaft connection part 320 illustrated in FIG. 7A. As illustrated in FIG. 10, the shaft connection part 320 is located between the driving unit 150 and the upper portion 111 of the drying furnace. The shaft connection part 320 transmits torque, and not only supplies the required power to the shaft heater 370 and the stirring blade heater 380, but also transmits an output signal of a shaft temperature sensor 360.

As illustrated in FIG. 10, wirings 330 are connected to an upper portion and a lower portion of a slip ring 340, respectively. The wiring 330 includes a heater cable 350 and a sensor signal line. The shaft temperature sensor 360 is installed in the upper portion of the stirring shaft 141 or in the stirring shaft 141 to detect temperature such as overheating or not and appropriate temperature.

### Operation of Exemplary Embodiment

Referring to FIGS. 7A to 9, the metal powder drying apparatus may first input the raw metal powder 105 used for manufacturing a secondary battery into the raw material input unit 100 to one side of the drying furnace 110. Here, the raw metal powder 105 is a metal powder containing at least one of lithium, nickel, cobalt, and aluminum, and may typically contain 4 to 12% by weight of moisture during the manufacturing process. In this case, as the raw metal powder 105 is input into the drying furnace 110, the weight of the drying furnace 110 increases, and the sensor 400 may detect the weight and transmit the detected weight to the control unit 10. When the weight of the drying furnace 110 exceeds a reference weight, the control unit 10 may stop the raw material input unit 100 to block the input of the raw metal powder 105.

Next, the stirring unit 140 installed in the drying furnace 110 rotates based on the first speed provided by the driving unit 150 to stir the raw metal powder 105, and while stirring, the raw metal powder 105 may be dried due to the heat generated by the heating unit 120.

More specifically, the first heating unit 121, the second heating unit 122, the third heating unit 123, the shaft heater 370, and the stirring blade heater 380 generate heat. In this case, the drying furnace is heated to a high temperature of 200 to 350° C. due to the heat generated by the heating unit 120. When the input amount is large or the moisture content is high (for example: exceeding 600 ppm), it is heated in the range of 280° C. to 350° C., and when the input amount is small or the moisture content is low (for example: less than or equal to 600 ppm), it is heated in the range of 200° C. to 240° C.

In addition, the area where the input raw material touches the bottom surface of the drying furnace 110 is larger than the area where the input raw material touches the side surface of the drying furnace 110. Therefore, it is preferable to control the temperatures of the first heating unit and the second heating unit (or the first and second floor heating units 210, 212) on the bottom surface to be 20° C. to 50° C. higher than that of the third heating unit (or the first and second side heating units 214 and 216) on the side surface. This is because the effect of selective heating is minimal below 20° C., and the unevenness of drying in the vertical direction worsens above 50° C. Next, the stirring unit 140 may rotate at a first speed to stir the raw metal powder 105. In

this case, the stirring shaft 141 of the stirring unit 140 receives the first speed from the deceleration motor of the driving unit 150, and the first speed may be 2 to 5 rpm as described above. In addition, the stirring blade 143 may stir the raw metal powder 105 while rotating at the first speed by the stirring shaft 141. In addition, the raw metal powder 105 may be slowly and uniformly pushed out to the outer periphery of the lower portion 113 of the drying furnace by the stirring.

Next, when the moisture content of the raw metal powder 105 inside the drying furnace 110 measured by the sensor 400 is 600 ppm or less, the stirring unit 140 may rotate based on the second speed provided by the driving unit 150 to discharge the mixed metal powder from the drying furnace 110. Here, the stirring shaft 141 of the stirring unit 140 receives the second speed from the deceleration motor 152 of the driving unit 150, and the second speed may be 6 to 11 rpm as described above. In this way, the stirring blade 143 rotating at the second speed may push the mixed metal powder 185 to the outer periphery of the drying furnace 110 in a faster time than when rotating at the first speed, and the mixed metal powder may be discharged to the lower side of the drying furnace 110 while pushing to the outer periphery. The mixed metal powder is a powder produced through the drying and stirring process and transferred to the transfer unit 180 connected to the discharge pipe 172 provided on the lower side of the drying furnace 110 and discharged to the outside while falling into the discharger 171 of the discharge part 170.

A detailed description of preferred exemplary embodiments of the disclosure disclosed as described above is provided to enable a person skilled in the art to implement or practice the disclosure. Although preferred exemplary embodiments of the present disclosure have been disclosed above, it may be understood by those skilled in the art that the present disclosure may be variously modified and changed without departing from the scope of the present disclosure. For example, a person skilled in the art may use each configuration described in the above-described exemplary embodiments by combining them with each other. Accordingly, the present disclosure is not intended to be limited to the exemplary embodiments illustrated herein but is to be given the widest scope consistent with the principles and novel features disclosed herein.

The present disclosure may be implemented in another specific form without departing from the spirit and the essential feature of the present disclosure. Therefore, the above-mentioned detailed description is to be interpreted as being illustrative rather than being restrictive in all aspects. The scope of the present disclosure is to be determined by reasonable interpretation of the claims, and all modifications within an equivalent range of the present disclosure fall in the scope of the present disclosure. The present disclosure is not intended to be limited to the exemplary embodiments illustrated herein but is to give the widest scope consistent with the principles and novel features disclosed herein. In addition, claims that do not have an explicit reference relationship in the patent claims can be combined to form an exemplary embodiment or can be included as a new claim through amendment after filing.

What is claimed is:

1. A metal powder drying apparatus using a plurality of plates including a heater for manufacturing a secondary battery, the metal powder drying apparatus comprising:
a drying furnace having raw metal powder used in the manufacturing of the secondary battery input into one side thereof and having an upper portion in a hemispherical dome structure;
a heating unit including the plurality of plates and provided on the one side of the drying furnace to heat the drying furnace;
a raw material input unit connected to the upper portion of the drying furnace and inputting the raw metal powder into the drying furnace;
a stirring unit installed in the drying furnace and stirring the raw metal powder input into the drying furnace;
a driving unit installed on an upper portion of the metal powder drying apparatus and providing a speed to the stirring unit; and
a control unit controlling the heating unit, the stirring unit, and the driving unit,
wherein the plate includes:
a heater provided inside the plate to receive power and generating heat; and
a temperature sensor provided inside the plate to measure a temperature of the plate and transmitting a measured value to the control unit,
the heating unit includes:
a first heating unit including the plurality of plates at a center of a bottom surface of the drying furnace;
a second heating unit including the plurality of plates along an outer side of the first heating unit at the bottom surface of the drying furnace; and
a third heating unit including the plurality of plates on an outer side surface of the drying furnace in a circumferential direction, and
the control unit controls a heat generation amount of each of the plurality of plates based on each of the measured values of temperature sensor.

2. The metal powder drying apparatus of claim 1, wherein the plate is made of any one of aluminum, iron, copper, an alloy thereof, and ceramics.

3. The metal powder drying apparatus of claim 2, wherein when the plate is cast, the heater and the temperature sensor are integrally cast.

4. The metal powder drying apparatus of claim 2, wherein an inside of the drying furnace is heated to 200 to 350° C. by operating the heater.

5. The metal powder drying apparatus of claim 4, wherein the temperatures of the first heating unit and the second heating unit are controlled to be higher than that of the third heating unit.

6. The metal powder drying apparatus of claim 1, wherein the driving unit includes a deceleration motor that provides a first speed and a second speed to the stirring unit, and
the first speed is 2 to 5 rpm, and the second speed is 6 to 11 rpm.

7. The metal powder drying apparatus of claim 1, wherein the plate of the first heating unit is 3 to 6 plates equally divided radially from the center of the bottom surface of the drying furnace.

8. The metal powder drying apparatus of claim 1, wherein the plate of the second heating unit is 4 to 12 plates equally divided radially from the center of the bottom surface of the drying furnace.

9. The metal powder drying apparatus of claim 1, wherein the plate of the third heating unit has a curved rectangular shape and is equally divided along a circumferential direction of the drying furnace.

10. The metal powder drying apparatus of claim 9, wherein the third heating unit includes:
a first side heating unit (214) arranged in a circle around the second heating unit and perpendicular to the second heating unit; and
a second side heating unit (216) having the same configuration as the first side heating unit (214) and stacked on the first side heating unit (214).

11. The metal powder drying apparatus of claim 1, wherein the plate is further provided with a bolt hole for fixing the plate to the drying furnace.

12. The metal powder drying apparatus of claim 1, wherein an insulating material or floor insulating material is further provided on an outer side of the plate.

13. The metal powder drying apparatus of claim 1, wherein the metal powder drying apparatus is a kettle dryer.

14. The metal powder drying apparatus of claim 1, wherein the heating unit further includes at least one of:
a shaft heater installed on a stirring shaft of the stirring unit; and
a stirring blade heater installed on a stirring blade of the stirring unit.
